(19) United States
(12) Patent Application Publication
(10) Pub. No.: US 2014/0114746 A1
(43) Pub. Date: Apr. 24, 2014

(54) Selection of Creatives Based on Performance Analysis and Predictive Modeling

(71) Applicant: ADOBE SYSTEMS INCORPORATED, San Jose, CA (US)

(72) Inventors: Abhishek Pani, San Francisco, CA (US); Zhenyu Yan, Sunnyvale, CA (US)

(73) Assignee: Adobe Systems Incorporated, San Jose, CA (US)

(21) Appl. No.: 13/656,497

(22) Filed: Oct. 19, 2012

(51) Int. Cl. G06Q 30/02

(52) U.S. Cl. 705/14.45; 705/14.72

(57) ABSTRACT

Methods and systems for testing, comparing, and optimizing creatives with multiple factors in digital advertising is presented. Experiments are designed for testing a plurality of factors combined to form a creative. Ad campaigns are launched or continue according to the design and the creatives' campaign performance data is collected. Statistical modeling and hypothesis testing are used to predict the performance of the creatives based on the performance data. The creatives are compared based on the predictions and either activated or deactivated based upon their relationship to statistical confidence levels. All the stages are executed automatically and iteratively.

### BACKGROUND

Digital advertising has significantly changed the way companies sell products and services. Where advertisers once performed surveys of focus groups over relatively long timelines to ascertain campaign performance, they can now obtain almost immediate feedback from the actual market.

Additionally, advertising campaigns incurred large upfront costs for production, (e.g. modeling, artwork, and musical production). This meant that a single campaign would have consistent or stable theme because once the upfront costs were sunk, it was expensive to change course. However, the relatively low cost of creating and altering digital advertising images, titles, and text body that describe digital marketing content provide advertisers the ability to adjust and tailor a campaign as they see fit, relatively inexpensively and responsively to the market.

In the context of internet advertising, tracking user interaction with a website is known as “web analytics.” Web analytics is the measurement, collection, analysis and reporting of internet data for purposes of understanding and optimizing web usage. Web analytics provides, for example, information about the number of visitors to a website and the number of page views, as well as providing information about the behavior of users while they are viewing the site. Web analytics may also capture performance measures of creatives.

### SUMMARY

Various embodiments of methods and apparatus for selecting creatives are presented. The method includes performing, by one or more computers, selection of a subset of creatives from a group of creatives for a campaign. Collecting performance data of the creatives during the campaign. Constructing a predictive model based upon the performance data to predict performance of creatives with little to no data. Performing statistical hypothesis testing based on the predicted performance to determine one or more creatives of the campaign to deactivate from the subset. Selecting, based on the predicted performance for each creative, one or more creatives from the group of creatives to replace the deactivated creatives in the subset for the campaign, and continuing the campaign and repeating for one or more iterations the collecting, constructing, performing and selecting of one or more creatives.

### BRIEF DESCRIPTION OF THE DRAWINGS

FIG. 1 illustrates an example network of systems configured to support automated selection and publishing of creatives suitable for an on-line advertising campaign in accordance with one or more other embodiments.

FIG. 2 depicts a creative manager that implements an automated process for selecting a preferred subset of creatives from a large set of creatives, according to some embodiments.

FIG. 3 is a table that illustrates exemplary candidate elements of advertisements (or “creatives”) that are part of an advertising campaign, according to one embodiment.

FIG. 4 illustrates a logical flowchart of a method for selection of preferred creatives in an advertisement campaign, according to one embodiment.

FIG. 5 depicts a logical flowchart of a method for selection of a subset of creatives including predictive model building and hypothesis testing, according to one embodiment.

FIG. 6 is a logical flowchart of an alternative method for selecting a subset of creatives according to one embodiment.

FIG. 7 depicts a high level logical flow chart illustrating the iterative nature of the creative selection process.

FIG. 8 is a table that illustrates a selected subset of creatives as part of an initial design and data collection, according to one embodiment.

FIG. 9 is a table illustrating the automated pausing and activating of creatives according to one embodiment.

FIG. 10 illustrates the automated addition of new elements to the creative selection process, according to one embodiment.

FIG. 11 is a table illustrating convergence of the preferred creative selection process, according to one embodiment.

FIG. 12 illustrates an exemplary computer system for use in implementing the selection of a preferred subset of creatives, according to one embodiment.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems are not described in detail below in order to not obscure claimed subject matter because they are well known by one of ordinary skill in the art.

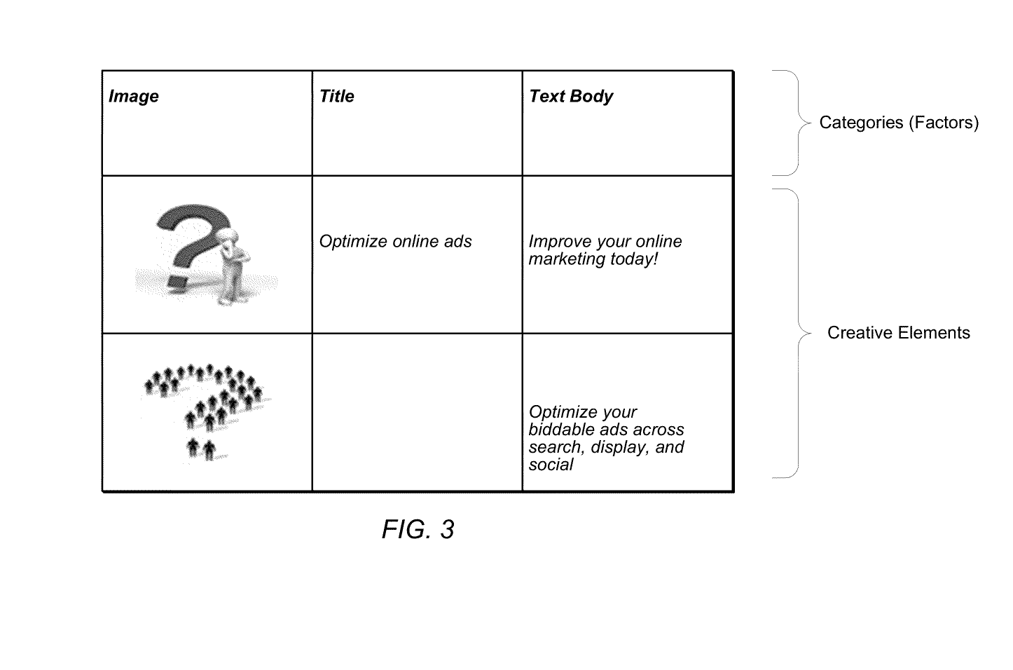

Various embodiments of methods and apparatus for selecting a subset from a group of creatives including an initial design and campaign kickoff followed by iterations of predictive modeling, hypothesis testing, subset selection and continued campaigning are disclosed. Advertising campaigns, especially on-line advertising campaigns use combinations of images, titles, bodies and other categories, (each individual category referred to as a factor) to create advertisements referred to as creatives. Many other categories may be employed as well, such as audio or video clips, animation, background color, etc. Advertisers may select which factors are particularly well suited for a particular audience, product, seasonality, demographic or based on other criteria and then provide elements embodying those factors for incorporation into creatives. Thus, a creative is a unique cross-product of multiple advertising factors embodied in the form of an advertisement incorporating elements from the chosen factors. Due to the many possible combinations, it may not be possible to test and compare all the candidate creatives within given budgets and other constraints. For example, for an advertisement campaign with M images, N titles, and K bodies, the total number of candidate creatives under consideration will be equal to M*N*K. Exemplary categories and creative elements are illustrated in FIG. 3.

A creative manager is a system that may carry out various methods capable of selecting a sub set of creatives from the total number in a more efficient and effective manner than prior methods. The creative manager may be implemented on one or more computer systems. In some embodiments, the creative selection system may be provided as a network-based service, such as a web service. In other embodiments, the creative selection system may be provided as or may include an application running on a user's computer.

In one embodiment the disclosed systems and methods implement a process for selecting a subset of creatives from a set of creatives provided by an advertiser. The process starts by obtaining the creative elements of the advertisements along with preferences and parameters from the advertiser to apply to the process. The disclosed system will design a model that intelligently groups the elements into a subset of creatives and then launch an advertisement campaign to collect data on the performance of the creatives. The system will use the collected data to build predictive models that produce predicted data for all of the possible creatives, even the ones that have little to no data because they were not in the campaign yet. Hypothesis testing is performed on the data to gain confidence in the deactivation of poor performing creatives from the subset. Sophisticated methods are then used to activate new creatives or creatives that were not in the prior subset and the campaign continues to run to collect more performance data. The process continues until it converges on a preferred subset of creatives.

The processes performed by the creative manager depend upon obtaining various types of data. For example, because some creatives are more effective than others, a creative manager may obtain performance data of the creatives for comparison. Performance data may be collected during an advertising campaign and used by the creative manager to adjust which creatives are selected for continuation of the campaign. The performance data indicates how well a particular creative performed during the advertising campaign. Exemplary performance data counts how many times a creative was selected (e.g. clicked on) compared to how many times it was displayed or which creatives had higher selection rates when paired with certain keywords of keyword-based advertising. The performance data of the creatives may be tracked and captured by third-party analytics systems and then sent to the creative manager for analysis.

Design models specify which elements are combined to form a particular subset of creatives and are designed in accordance with advertisement parameters which may be provided by the advertiser and place constraints on the model design. As described in more detail herein, a design model that does not depend upon observed performance data is sometimes referred to as an experimental design and a design that uses other types of data (e.g. predicted performance data or experimental design model data) in addition to the observed performance data is sometimes referred to as an augmented design model. The creative manager launches or continues an advertising campaign based upon the design model. In one embodiment, launching or continuing a campaign may be carried out by sending the details of the design model to a publisher system, which places the creatives as advertisements on the content sites such as Facebook® or Google®, for example. Once the campaign has been launched, performance data of the creatives may be collected. In some embodiments a third-party analytics provider monitors the advertising campaign and collects the performance data but, the advertiser or the creative manager could collect the performance data in other embodiments.

The creative manager will use the collected performance data to build predictive models that can forecast the performance of all the potential creatives. This is where a great improvement in efficiency comes from since it empowers advertisers to make intelligent decisions about which creatives to use without testing each and every possible creative in a campaign. In some embodiments the prediction is of previously tested and untested creatives while in other embodiments, only untested creatives are predicted. The predictive modeling may be skipped if there is not enough data. Now that all creatives have performance values (either observed or predicted) they can all be compared.

Some embodiments involve performing hypothesis testing based on the predicted performances to measure the confidence level of the comparison results. In some embodiments, the hypothesis testing may include simultaneous hypothesis testing, which is a way to reduce mistaken inferences that are actually more attributable to chance than the data would suggest from a more casual observation. Such mistaken inferences are referred to as the multiple comparison problem and occur when one considers a set of statistical inferences simultaneously or infers on selected parameters only, where the selection depends on the observed values. Hypothesis testing determines if the performance data results are unlikely to have occurred by chance alone and involves making a determination based upon a threshold value. The threshold value may be configurable and may be provided by the advertiser as part of the advertising parameters for example.

The creative manager uses the results from the hypothesis testing to compare performance data and deactivate poor performing creatives from the campaign. The deactivation may be performed by determining whether the performance data of a particular creative fell under a certain statistical confidence level of the comparison results. The confidence level may be a configurable parameter and may be provided by a user or by the advertiser, for example, as part of the selection preference parameters associated with the creative selection effort.

In some embodiments the creative manager selects one or more inactive or new creatives to include in a next iteration of the continuing campaign, along with creatives currently in the campaign that were not deactivated, to form a new subset. The creatives to be selected may be creatives that were newly introduced or creatives that were not in the last iteration of the campaign but are not new either (i.e. unselected creatives from the group that the sub group was selected from). New creatives may be introduced via a user interface of the creative manager or via an application interface with the advertiser systems for example. In some embodiments, a constraint may be applied on the selecting to ensure that the selected one or more creatives were not in an immediately prior performed iteration of campaign.

If there are new creative elements, selection of the subset may be based, in part, upon the performance data of creatives that have performance data and, in part, on a design model considering creatives with the new elements. Selection of a new or inactive creative is call activation. Activation based upon the performance prediction is sometimes called exploitation while activation based upon a design model of new elements is sometimes referred to as exploration. In one embodiment, a ratio is used to allocate a preference for either the new or not-new creatives. The ratio may be configurable and may be obtained as part of the preference parameters via a user interface or from the advertiser. In one embodiment, if there are not new creative elements, selection of the sub group is based on the performance data, prediction model results and hypothesis testing as described above.

In some embodiments, the campaign continues, but with a new subset replacing the deactivated creatives with the selected creatives. More performance data of the creatives is collected and the process may continue, repeating the process of build a predictive model, perform hypothesis testing, deactivate creatives, activate creatives, campaign and collect performance data, for one or more iterations until a preferred subset is determined.

The creative manager may perform an alternative process when the performance data are insufficient to build predictive models, such as when there has been an improper initial design, data loss, etc. With no need of building a predictive model, the process proceeds directly to hypothesis testing on the observed performance data directly, compares the performance data and deactivates inferior creatives from the corresponding subset of the campaign under a certain statistical confidence level of the comparison results. Because there are no predicted performances of creatives, exploitation is not possible in this path. Instead, only exploration is performed, i.e., with the existing creatives as the set, the creative manager creates an augmented design model. Note that this part of the process can also take newly user-added elements into consideration when necessary.

### Systems for Preferred Selection of Creatives

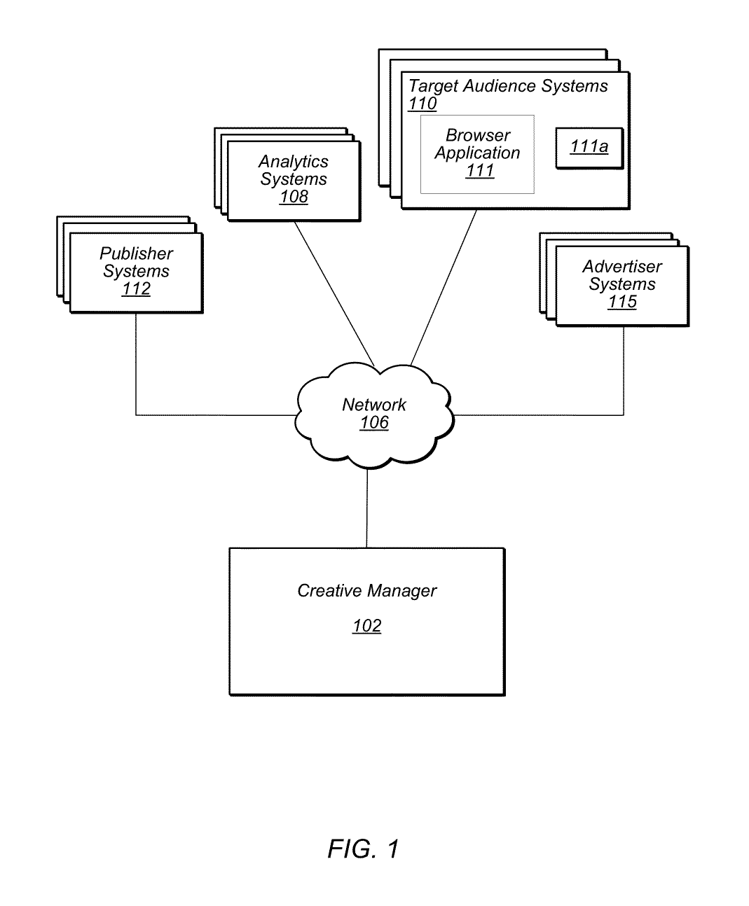

FIG. 1 illustrates an example creative manager configured to support automated data collection, model design, hypothesis testing, creative deactivation and activation and campaign execution for a subset of creatives in accordance with one or more other embodiments. A creative manager in accordance with one or more embodiments is employed to accumulate and/or process data associated with creatives' performance and advertising data associated with the selection effort to select a preferred subset of creatives. The illustrated embodiment includes analytics systems 108, target audience systems 110, publisher systems 112, advertiser systems 115 and creative manager 102.

Each of analytics systems 108, target audience systems 110, publisher systems 112, advertiser systems 115 and creative manager 102 may be communicatively coupled to one another via a network 106. In some embodiments, network 106 includes one or more electronic communication networks, such as the Internet, a local area network (LAN), a cellular communications network, or the like. Network 106 may include a single network or combination of networks that facilitate communication between each of the entities.

In one embodiment, advertiser systems 115 design the images, write the text and determine titles suitable for the selection effort of the creatives. These elements are transmitted to the creative manager as part of the advertising data which may also include advertising parameters and selection preferences. An exemplary, non-exhaustive list of advertising parameters includes publishers, ads placements, target audiences, campaign budgets and candidate elements of creatives. An exemplary, non-exhaustive list of selection preferences includes the maximum number of active creatives (n), time scope of performance data to be used for modeling and comparison (start date and end date), exploitation and exploration ratio, half-life for the decay of the importance of the performance data and significance level for making a decision. The creative manager will use the advertising parameters to create a campaign that meets the constraints of the selection preferences as described in further detail below.

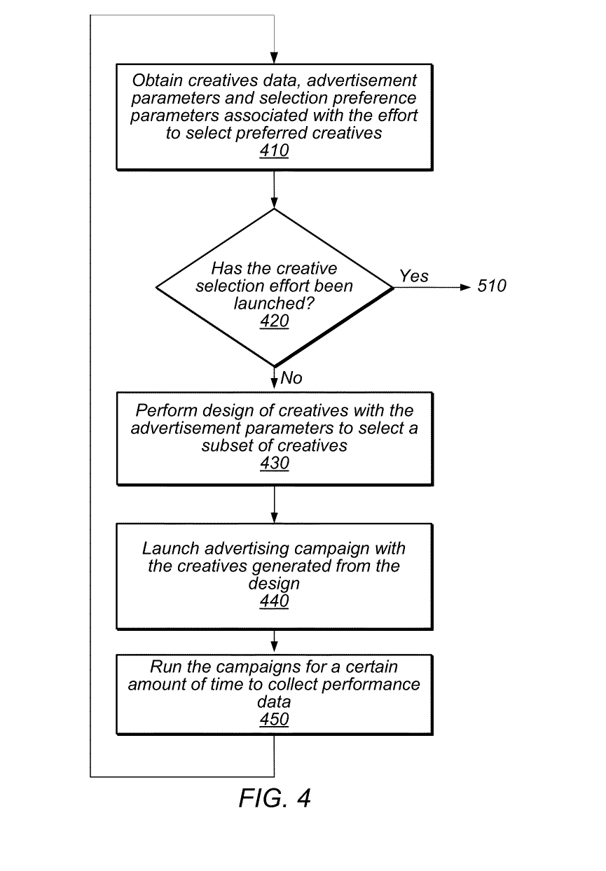

The creative manager 102 uses the creative elements from the advertiser system along with other advertiser data to select a subset of creatives best suited for an advertising campaign. A detailed selection process is provided in FIGS. 4-6. In some embodiments, creative manager 102 retrieves advertising data (e.g. creative elements, from advertiser systems 115 while in other embodiments, the data may be stored locally to creative manager 102. Creative manager 102 may also retrieve performance data of the creatives from analytics systems 108 or, the performance data may be stored locally to creative manager 102. In one example, performance data includes performance data for each creative; in another example, performance data includes data for only some creatives.

In one embodiment, creative manager 102 starts the selection process by selecting an initial subset of creatives. The initial subset is selected by performing an initial design of a model that describes a representative subset of creatives from the set of all possible creatives. Sometimes this initial design is referred to as experimental design because it is not based upon analysis of observed performance data. Design models specify which elements are combined to form a particular creative for the entire subset of creatives and are designed in accordance with advertisement parameters which may include publishers, ads placements, target audiences, campaign budgets, factors (e.g., image, title, and text body) and candidate elements of creatives, etc. In one embodiment, the creative manager builds a design model according to advertisement parameters including the various elements that make up the creatives and preference parameters such as the maximum number of active creatives (n) and time scope of performance data to be used for modeling and comparison (start date and end date). Because in early stages of the process little to no performance data is available, a design model attempts to maximize the information that can be collected under a certain constraint (e.g., maximum number of active creatives). As such, a design model may include at least one instance of very element somewhere among the group of creatives in the subset so as to ensure more accurate and comprehensive testing of all the elements. However, as described below, not every possible combination of elements need be represented by a creative in the subset and in some embodiments, not every element may be represented. More details of the initial design process are described with reference to FIG. 4, below.

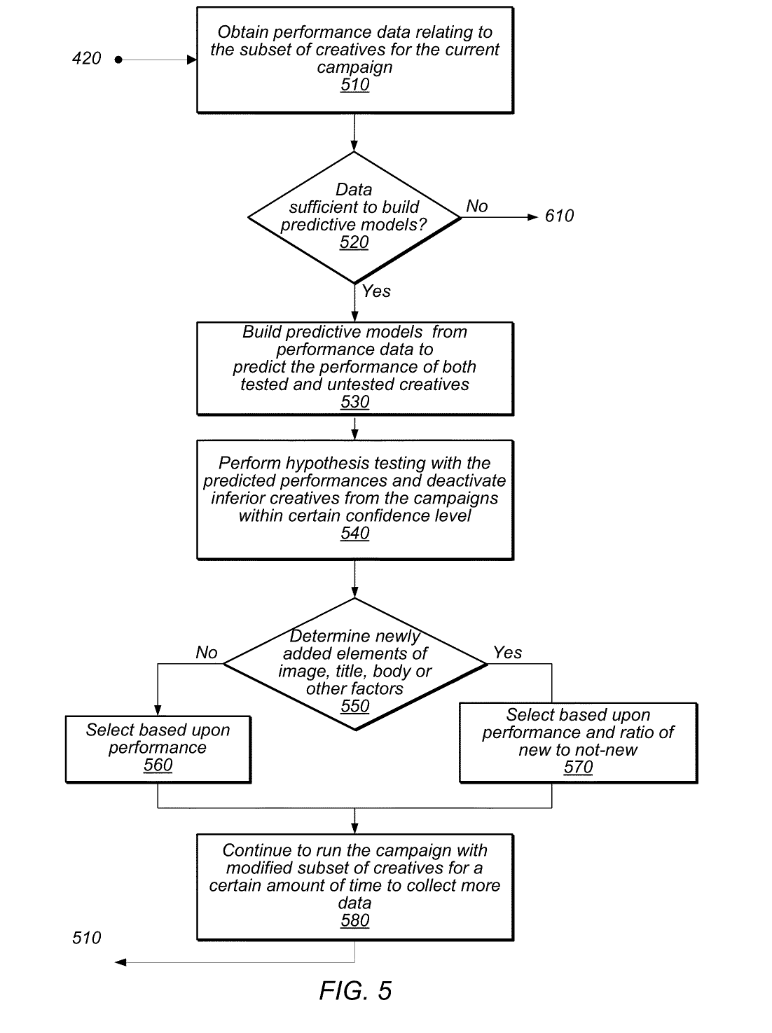

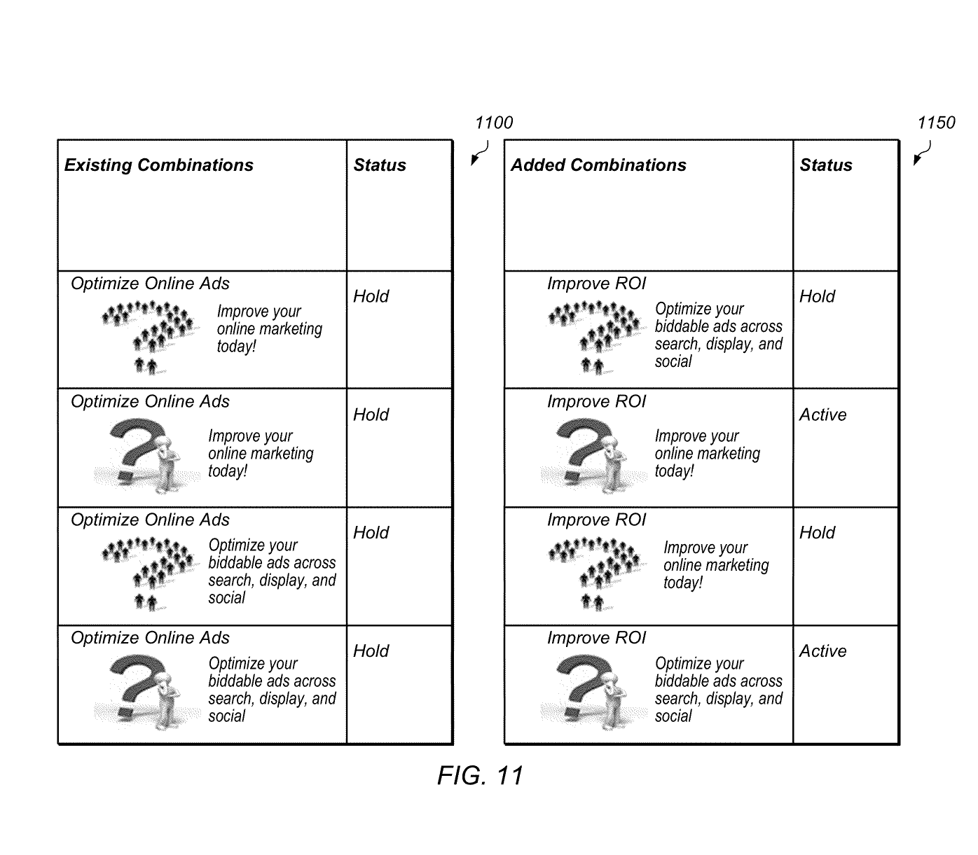

In some embodiments, the creative manager 102 launches a campaign according to the initial design model. Launching a campaign may involve delivering the selected subset of creatives to the publisher system 112 along with other advertisement parameters used by the publisher system to place the creatives as ads on target audience systems 110. Analytics systems 108 may track the creatives on target audience systems 110 and collect performance data of the creatives. In one embodiment, creative manager 102 constructs a prediction model based upon the collected performance data. In one example, predicting the performance of the creatives includes creative manager 102 building a predictive model for predicting the performance of creatives through statistical modeling and uses hypothesis testing methods to compare the results. In some embodiments, creative manager 102 may perform hypothesis testing based on the predicted performance to determine one or more creatives to deactivate. In one example, the hypothesis testing includes simultaneous hypothesis testing. In a further embodiment, creative manager 102 may select one or more inactive creatives to activate in a next iteration of the continuing campaign along with creatives currently in the campaign that were not deactivated to form a new subset of the creatives. In some embodiments, a constraint may be applied on the selecting to ensure that the selected one or more creatives were not in an immediately prior performed iteration of the campaign. Creative manager 102 may continue the campaign with the new subset of creatives and repeat the process for one or more iterations. For example, the process may continue to iterate until convergence on a preferred set of creatives is achieved. More details of the predictive model building, hypotheses testing, deactivation and activation are described with respect to FIG. 5, below. Convergence is described with regard to FIG. 11, below.

Sometimes the performance data are insufficient to build predictive models. In some embodiments, creative manager 102 performs an alternative design by balancing an exploitation of the performance data with an exploration of new element(s) through experimental design wherein a balance between the exploitation and the exploration is based upon a parameter, e.g., a ratio. In one example, the parameter may be configurable and may be defined by advertiser systems 115; in other examples the parameter may be defined by the creative manager 102 or a user.

Publisher systems 112 may include computers or similar devices used to publish content from content web sites (e.g. Facebook, Google, other web sites, advertising servers, etc.) to target audience systems 110 along with advertisements using the creatives. Publishing computing systems 112 may include content servers for providing web content such as html files that are loaded by target audience systems 110 for viewing webpages of publisher systems 112. In one embodiment, publisher systems 112 accept the selected subset of creatives from creative manager 102 and publish the creatives as advertisements on the content web sites.

Target audience systems 110 may include a computer or similar devices used to interact with publisher systems 112. In some embodiments, target audience systems include a wireless device used to access content (e.g., web pages of a websites) from publisher systems 112 via network 106. For example, target audience systems may include a personal computer, a cellular phone, a tablet, a personal digital assistant (PDA), or the like.

In some embodiments, target audience systems 110 include an application (e.g., internet web-browser application) 111 that can be used to generate a request for content, to render content, and/or to communicate request to various devices on the network. For example, upon selection of a website link on a webpage 111a displayed to the user by browser application 111, the browser application 111 may submit a request for the corresponding webpage/content to publishing computing systems 112, and the publishing computing systems 112 may provide corresponding content, including an HTML file, that is executed by a browser application 111 to render the requested website for display to the user. In some instances, execution of the HTML file may cause browser application 111 to generate one or more additional requests for additional content (e.g., an image referenced in the HTML file as discussed below) from a remote location, such as advertiser systems 115 and/or analytics systems 108. The resulting webpage 111a may be viewed by a user via a video monitor or similar graphical presentation device of target audience system 110. While a webpage 111a is discussed as an example of the network content available for use with the embodiments described herein, one of skill in the art will readily realize that other forms of content, such as audio or moving image video files, may be used without departing from the scope and content herein disclosed. Likewise, while references herein to HTML and the HTTP protocol are discussed as an example of the languages and protocols available for use with the embodiments described herein, one of skill in the art will readily realize that other forms of languages and protocols, such as XML or FTP may be used without departing from the scope and content herein disclosed.

In one embodiment, analytics systems 108 includes a system for the tracking and collection and processing of performance data for creatives, and the generation of corresponding performance metrics. Performance data of the creatives may include information relating to the activity and interactions of one or more users with a given website, webpage or creative. For example, performance data may include historic and/or current website browsing information for one or more website visitors, including, but not limited to identification of links selected, identification of web pages or creatives viewed, identification of conversions (e.g., desired actions taken—such as the purchase of an item), number of purchases, value of purchases, and other data that may help gauge user interactions with webpages/websites/creatives. In some embodiments, performance data of the creatives is accumulated over time to generate a set of analytics data (e.g., an analytics dataset) that is representative of activity and interactions of one or more users with a given website, webpage, advertisement or creative. Analytics data may be processed to generate metric values that are indicative of a particular trait or characteristic of the data (e.g., a number of website visits, a number of items purchased, value of items purchased, a conversion rate, a promotion effectiveness index, etc.).

A non-exhaustive, exemplary list of network site analytics metrics includes click through rate (CTR), conversion rate, revenue per click (RPC), revenue per impression (RPM), cost per click (CPC), cost per action (CPA), and cost per impression (CPM), etc. Collected data may also include analytics reports including various metrics of the analytics data (e.g., a promotion effectiveness index and/or a promotion effectiveness ranking). The performance data may include data that describes usage and interactions between users and advertisements (e.g. creatives) within the website (e.g. one of content publisher systems 112, or a website linked by a creative). Analytics systems 108 may include a third-party website traffic statistic service. In the illustrated embodiment, for example, analytics systems 108 are communicatively coupled to target audience systems 110 via network 106. Analytics systems 108 may receive analytics data from target audience systems 110, server logs, web bugs and the like. Accordingly, in one embodiment, analytics systems 108 may assess performance of creatives to assess an effectiveness of one or more promotions or campaigns using the creatives and perform trend ascertainment and predictive functions described herein.

Analytics systems 108 collect data via various methods. For example, Analytics systems 108 may service requests from one or more target audience systems 110. For example, upon loading/rendering of a webpage 111a from publisher systems 112 by browser 111 of target audience systems 110, browser 111 may generate a request to analytics systems 108 via network 106. Analytics systems 108 may process the request and return appropriate content (e.g., an image) to browser 111 of target audience systems 110. In some embodiments, the request includes a request for an image, and analytics systems 108 simply returns a single transparent pixel for display by browser 111 of target audience systems 110, thereby fulfilling the request. The request itself may also include web analytics data embedded therein. Some embodiments may include publisher systems 112 embedding or otherwise providing a pointer to a resource, known as a “web bug”, within the HTML code of the webpage 111a provided to target audience systems 110. The resource may be invisible to a user, such as a transparent one-pixel image for display in a web page. The pointer may direct browser 111 of target audience systems 110 to request the resource from analytics systems 108. Analytics systems 108 may record the request and any additional information associated with the request (e.g., the date and time, and/or identifying information that may be encoded in the resource request).

Analytics systems 108 may parse the request to extract the performance data contained within the request. Performance data may be stored in a datastore at analytics systems 108, or datastore 114 or a similar storage/memory device, in association with other accumulated web analytics data. Analytics systems 108 or preference provider 102 may process the performance data to generate one or more performance reports, including graphical displays and trend and prediction analysis. For example, analytics systems 108 or preference provider 102 may filter the raw performance data to be used by preference provider 102 in generating models and predictions. Reports, for example, may include overviews and statistical analyses describing the rate of converting a website visit to a purchase (e.g., conversion), an effectiveness of various promotions, and so forth, and identifying trends in and making predictions from the data as requested.

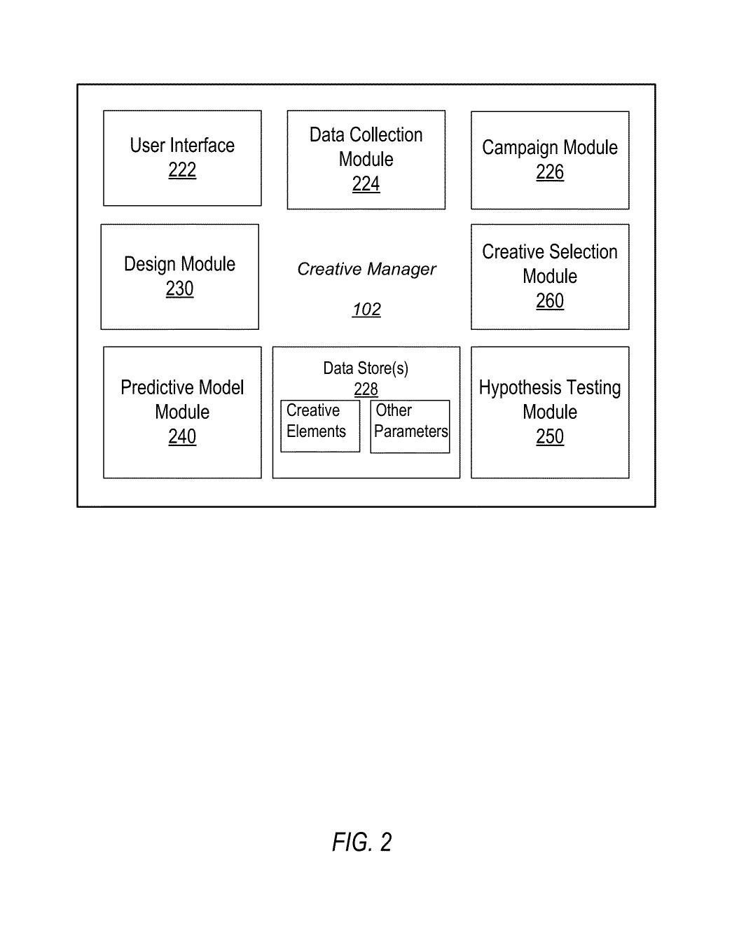

FIG. 2 depicts an exemplary embodiment of a creative manager that implements selection of preferred creatives. In order to select an initial subset of creatives for an advertising campaign, creative selection module 102 may include a design module 230. Based on a set of creative elements (e.g., supplied by a user, such as from an advertising computer system 115), the design module 230 may create a subset of creative using different combinations of the creative elements. The number of creatives in the subset may be specified by a configuration parameter, e.g., supplied by the user or advertiser. In some embodiments, the design module 230 may create a subset of creatives by randomly selecting a creative element from each different category of creatives to provide the desired number of creative for the initial subset. However, in other embodiments, the design module 230 may perform a creative design process that chooses creatives based on a selection of creative elements from the different categories of creative elements in a manner that will improve or optimize the amount of information that can be learned when the creatives are run in a campaign. For example, the creative design process may ensure that the creatives in the subset include a representative sampling or even distribution of creative elements from each creative element category. Having a representative sampling of elements from each category may allow creative selection system 102 to make more accurate performance predictions for other creatives that have not yet been tested, as discussed in more detail below. If creatives are designed randomly, then by chance the creatives may include only a very small sampling of creative elements from one or more of the creative element categories. If the initial creative subset is poorly designed, then when the subset of creatives is run in a campaign insufficient performance data may be collected to predict how other creatives may perform that are based on other elements from the under-represented categories.

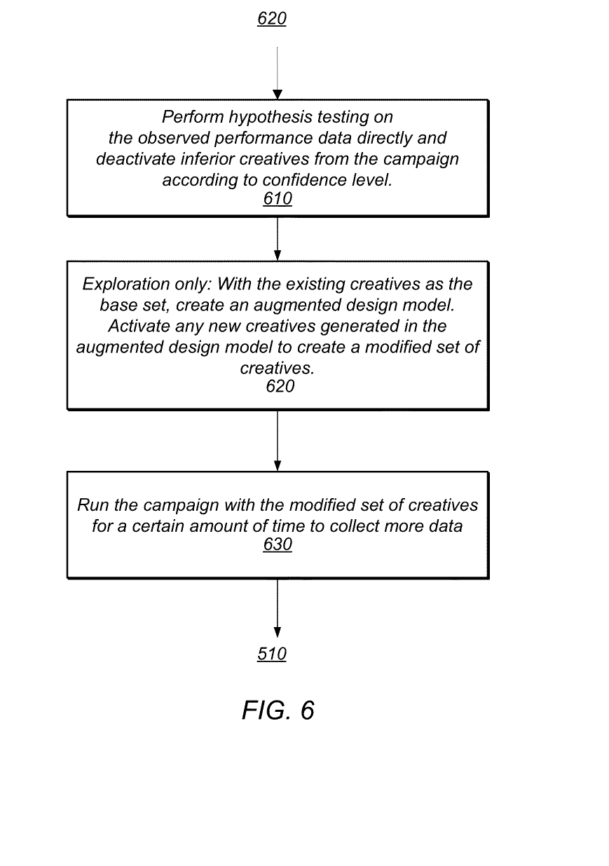

In some embodiments, creative manager 102 includes a predictive model module 240 for predicting the performance of all the creatives based on the performance data of the subset of creatives. In one example, creative manager executes the following two-fold method (described in more detail in FIG. 6). If the data are sufficient, the creative manager 102 may instruct the predictive model module 240 to build a performance prediction model to create additional data for comparison of the performances and hypothesis testing. However, if the data are not sufficient to build the predictive model, creative manager 102 will perform an alternate process by skipping the predictive modeling and instructing the hypotheses testing module 250 to perform hypothesis testing directly on the observed performance data as described in more detail with regard to FIG. 6, below.

In one embodiment, when the data is sufficient, hypothesis testing module 250 performs hypothesis testing in concert with the predictive modeling to measure the confidence level of the comparison results. The confidence level may be a threshold as discussed above. Hypothesis testing is discussed below in regard to FIG. 5.

The creative selection module 260 activates and deactivates creatives for the subset. The creative selection module deactivates creatives identified as poor performers via predictive modeling and hypothesis testing. Also, after a design is performed, the creative selection module 260 activates the creatives indicated by the design. In some embodiments, the creative selection module 260 will take action (activating and deactivating a creative) only if a certain confidence level is reached during hypothesis testing. In some embodiments, the creative selection module 260 will activate the creatives identified by the exploration and exploitation processes to fill the vacancies created by deactivation, as illustrated in FIG. 5. Once a subset of creatives has been selected by the creative selection module 260 the campaign will continue by using the subset.

Campaign module 226 launches campaigns. In one embodiment, a campaign includes an iterative series of subsets of creatives displayed as advertisement messages that share an idea and theme which make up an integrated marketing communication. In one example, subsets of creatives from advertising campaigns appear in different media across varying time frames. In one embodiment, campaign module 226 may send campaign data to publisher systems 112 to run on various content sites at various times according to advertising parameters and preferences. In another example, campaign module 226 launches or continues a campaign directly by providing services normally provided by the advertising computing systems 115. Campaign module 226 may instruct publisher systems 112 to run or continue the campaign for a certain amount of time in order to collect more performance data. Thus, exemplary campaign data may include the subset of creatives that are selected for the current iteration of the campaign and other criteria that may be determined from the advertising data such as parameters and preferences and the amount of time to run the current iteration of the campaign and collect more data

Data collection module 224 requests, receives and delivers data. The data may be elements and advertising parameters and preferences from the advertiser systems 115, performance data of the creatives from analytics systems 108 or input from the user via user interface 222. Data collection module 224 may interact with the various systems via application programming interfaces (API) for example. Data collection module 224 may also interact with any of the other modules within creative preference processing module 102 as needed, receiving or sending data via API or otherwise.

In some embodiments, creative manager 102 may provide a user interface 222 for facilitating user interaction with the creative manager 102, for example to accept user input, add new elements for the creatives, obtain a set of advertiser parameters and preferences, activate an analysis tool, configure displays, and set configurable independent variable values such as the exploitation and exploration ratio, etc. For example, the user interface may be provided via a web browser supported application, proprietary application user interface and the like.

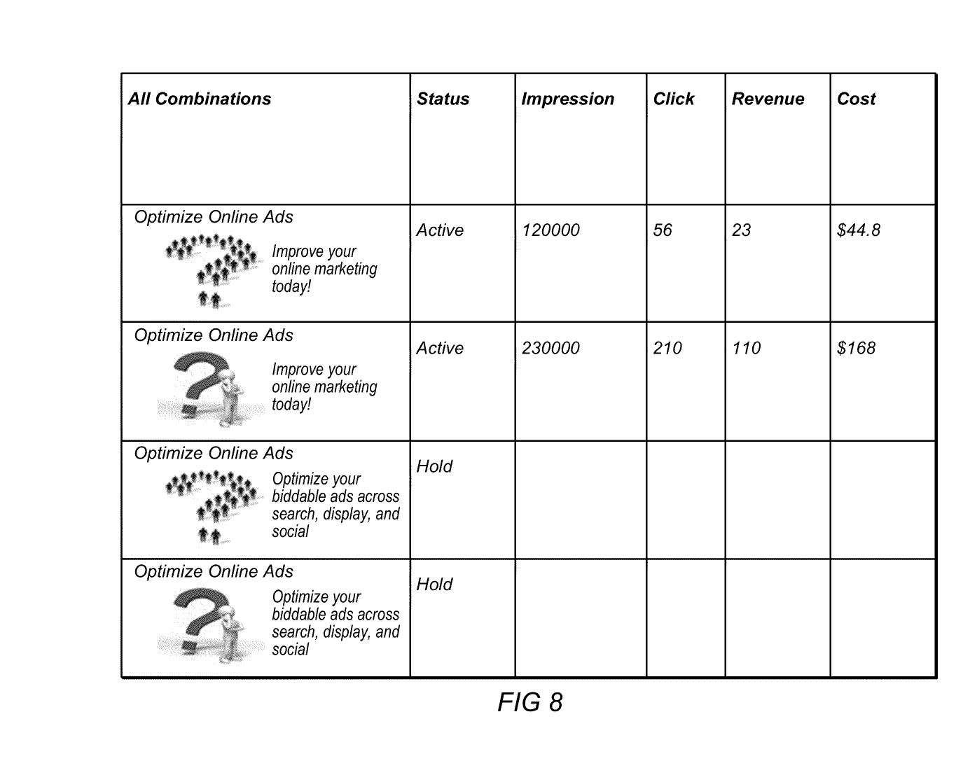

FIG. 3 is a table that illustrates exemplary candidate elements of advertisements (or “creatives”) that are part of an advertising campaign, according to one embodiment. The table headings: Image, Title and Text Body are the factors (categories) available for the campaigns illustrated in FIGS. 8-11. The image factor has two particular elements (a solid question mark with a single humanoid as well as a question mark made of multiple humanoids). The title factor has one element, “Optimize online ads.” The text body factor has two elements, “Improve your online marketing today!” and “Optimize your biddable ads across search, display, and social.” Note the total number of available creatives is 2*1*2=4 possible creatives.

### Operations for Implementing Selection of Creatives

FIG. 4 depicts a high-level logical flowchart of operations performed by creative manager 102 to implement one embodiment of creative selection, according to some embodiments. Performance data pertaining to creatives, advertising data including advertisement parameters and preference parameters associated with a preference selection effort may be obtained (block 410) from either manual entry via user interface 222 or via an automated data collection process involving data collection module 224. In some embodiments the data is communicated via network 106, facilitated by application programming interfaces (API) among creative manager 102, advertiser systems 115, publisher systems 112 and analytics systems 108. The advertisement parameters may include publishers, ads placements, target audiences, campaign budgets, factors (e.g., image, title, and text body) and candidate elements of creatives, etc. Exemplary, preference parameters may include the maximum number of active creatives (n), time scope of performance data to be used for modeling and comparison (start date and end date), exploitation and exploration ratio, half-life for the decay of the importance of the performance data, and significance level for making decision, etc.

Some embodiments support both “cold-start” and “warm-start” processes. “Warm-start” refers to the situation when there are existing data and a campaign matched to the current creative selection effort. In this case, a creative selection effort will be determined (block 420) to the existing data and campaign obtained in block 410 and thus initial experimental design is not needed to create the performance data. The process may then go to 510, described below with reference to FIG. 5. “Cold-start” represents a more common situation in which the creative selection effort starts from scratch (i.e. little to no performance data) and an initial experimental design is required to create performance data. Besides “warm-start”, any iteration of the process after the first iteration may receive a “Yes” in block 420, because the creative selection effort may have been launched after the first iteration for either “cold-start” or “warm-start” case. Thus, at block 420, a determination is made whether a creative preference selection effort has been launched. If the answer is yes, then it will go to block 510. If the answer is “No”, an initial experimental design will be executed (block 430).

Initial experimental design of creatives with the advertisement parameters and preferred parameters is performed by design module 230 to select (block 430) a subset of creatives. An exemplary goal of the initial design is to maximize the information that can be collected under a certain constraint (e.g., maximum number of active creatives) and eventually can maximize the prediction and comparison accuracy in later stages. In one embodiment, a preference criterion is

$$maximize \text{:} \vert \frac{{X}^{T} X}{n} \vert .$$

Where n is the maximum number of active creatives allowed; n may be provided by the user in block 410 or in an automated manner, for example via API with advertiser systems 115; X is the design matrix derived by the process automatically; |A| represents the determinant of square matrix A. Superscript T is the transpose or inverse square matrix. In one embodiment, campaign module launches an advertising campaign with the creatives generated from the initial experimental design for the preference selection effort (block 440). The iteration of the campaign runs for a certain amount of time to collect creative performance data (block 450). The amount of time may configurable and may be determined by user identified parameters 212 or selection preference parameters from advertiser systems 115. Now that the creative preference selection effort has been launched, the answer to block 420 is yes and the process proceeds to block 510.

### Operations for Implementing Predictive Analysis of Creatives Performances

FIG. 5 depicts a logical flowchart of a method, performed by creative manager 102, for deactivating creatives from the subset via predictive model building and hypothesis testing and activating new or non-activated creatives, according to one embodiment (an illustrated example of selected creatives is explained with regard to FIG. 8 below). Advertisement parameters and performance data relating to the preference selection effort are retrieved for the current advertising campaign (block 510) and a two-fold method is used to analyze the data. For example, a determination is made whether there is sufficient data to build predictive models (block 520). One way to determine whether the data is sufficient is to compare the mean and confidence levels around the mean for any two creatives. It is then possible to draw a conclusion with a certain confidence level. In one example for the cold-start case, because the process has gone through initial design, it is most likely that the data will be sufficient. This case will receive a “Yes” and the process will proceed to block 530. Note that in an example of the warm-start case, because the process has not gone through the initial design, it is possible that the data are not sufficient to build predictive models due to the improper initial design. This case will receive a “No” and proceed to block 610. Even for the cold-start case with experimental design, the data could be insufficient due to unexpected data problems, such as loss of data, failure in posting some of the creatives (e.g., creatives disapproved by the publishers), etc. Thus, the proposed two-fold approach provides a robust and fault-tolerant way to deal with such problems.

For example, if the data are not sufficient to build the predictive model, creative manager 102 will perform an alternative process capable of handling low or no amounts of performance data as described in detail with reference to FIG. 6, below. However, if the data are sufficient, predictive model module 240 builds a predictive model and compares the performances of the creatives based on the predicted results (block 530). Predictive models are built by predictive model module 240 from performance data to predict the performance of both tested and untested creatives (block 530). Selection module 260 may use these results to activate and deactivate creatives in a subset after the results are compared with hypothesis testing, described below. Note that there may be a variance for the tested creatives and thus, the tested creatives would benefit from the prediction model as well. The models could be linear regression models, generalized linear models, decision trees, neural networks, or any other predictive models. A general form of the model can be:

y=ƒ(x)+ε

X is a vector of factors that define a creative and f is a function that transforms x to a performance value y. The performance value can broadly include any or a combination of various metrics or objectives supplied by the users. For example, it can include click through rate (CTR), conversion rate, revenue per click (RPC), revenue per impression (RPM), cost per click (CPC), cost per action (CPA), and cost per impression (CPM), although other metrics and objectives are contemplated as well. Preferred models not only predict the mean performance but may also give the distribution of the performance. Such model attributes may be useful for the hypothesis testing described herein. For linear or generalized linear models, the distribution can be obtained directly. For more complicated machine learning models, such as neural networks, bootstrapping may be used.

Hypothesis testing is performed (block 540) by hypothesis testing module 250 with the predicted performances. Because there is usually more than one pair of creatives under comparison, it is easy to draw inaccurate conclusions if the multiple comparisons problem is not properly addressed. Simultaneous hypothesis testing may be used to prevent such common pitfalls in multiple comparisons. The results of the hypothesis testing are used by selection module 260 to deactivate inferior creatives from the subset of the campaign within a certain confidence level (540). The confidence level may be a user provided parameter obtained via user interface 222 or via advertising data from the advertiser systems 115. Note that whether to maximize or to minimize the performance metrics depends on the underlying performance metrics. In some embodiments tested predictions are treated the same as performance data.

### Incorporation of New Elements

Systems may generally be categorized as open or closed systems. In a closed system, parameters and preferences and creative elements are all determined, usually manually, and then the system runs through data collecting, modeling, simulation and selection and then stops to provide the selected creatives as output to businessmen who apply their own business rules to the selected group and then run a new campaign. Under such a closed system scheme, it is not possible to incorporate new creative elements into the system without stopping the process and starting over. An open system provides for automated incorporation of new elements without restarting the process. In some embodiments, the creative manager 102 comprises an open system wherein one or more creatives intended for consideration in a next iteration of the campaign include newly introduced elements that were not considered for a prior iteration of the campaign.

In one embodiment, the new elements can be added at any time and may be stored in the datastore(s) 228. In another embodiment, new elements are created and stored at advertising computing systems 115 or publisher systems 112 and their associated preference data and advertising data are retrieved by data collection module 224. Newly added elements of image, title, body or other factors are determined (block 550) by design module 230. Note that an element may be considered new if it has not been considered in previous iterations. If no new elements are determined, then inactive creatives will be activated by selection module 260 via an exploitation analysis (block 660). Activation at this point may fill the vacancies created by the deactivated inferior entries in block 540. If new elements are determined at block 550, then the next set of creatives will be selected (block 570) by the selection module using a balance of exploitation and exploration which includes two parts. Part 1 includes assigning a portion of the vacancies to inactive creatives with top predicted performances and activating those creatives. Part 2 includes running an augmented experimental design with the existing design and the newly added creatives in exploitation as a base. The augmented experimental design, created and run by design module 230 will be used by selection module 260 to select candidate creatives with newly added elements for activation into a modified subset. Note that the exploitation illustrated in block 570 may be similar to the exploitation in block 560. Exploration, however, indicates an activation decision based on an experimental design with new elements. A balance between exploitation and exploration may be based upon a ratio parameter provided at block 510. Through this mechanism the system will activate creatives with good predicted performances. Meanwhile guided by experimental design, it also will explore new elements and creatives whose performances cannot be predicted with current performance data. An iteration of the campaign is run (580) with the modified subset of creatives for a certain amount of time to collect more performance data. The process may then return to block 510.

FIG. 6 is a logical flowchart of an alternative method for selecting a subset of creatives according to one embodiment and provides an alternative path when the performance data are insufficient to build predictive models (block 520, no). Both the possible improper design problem in warm-start and the data loss problem can be handled automatically by the alternative path in FIG. 6. This path may be appropriate when there is no good design, when the data is insufficient or when the matrix is singular. The augmented experimental design in block 620 will try to fix those problems and eventually the method will be able to build predictive models to predict both observed and unobserved performances (blocks 530 and 540 in FIG. 5).

In one embodiment, with no need of building a predictive model, simultaneous hypothesis testing is performed (block 610) on the observed performance data according to the user defined performance metrics directly. The results of the simultaneous hypothesis testing are used to deactivate (block 610) inferior creatives from the corresponding subset of the campaign under a certain confidence level. Note that because there are no predicted performances of creatives, exploitation is not possible in this path. Instead, only exploration is performed, i.e. the design module 230 will run an augmented design with the existing creatives as a base (620). However, note that at this point, the creative manager 102 can also take new, user-added elements into consideration, as contemplated in further embodiments (the same exception applies to block 550 in FIG. 5). Campaign module 226 may run an iteration of a campaign with the selected subset of creatives for a certain amount of time to collect more data (block 630) and then the process may go back to block 510. If there is no new input of elements and after some iteration, the process will likely converge to the preferred set of creatives in a number of iterations (details of convergence are explained below in reference to FIG. 11). If new elements are continually added, the process may not converge.

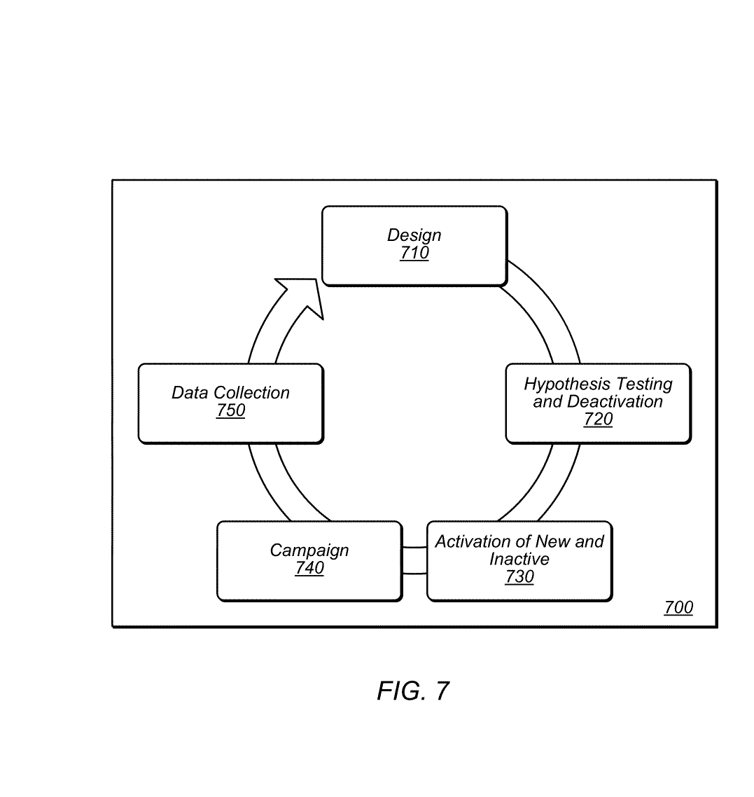

FIG. 7 depicts a high level logical flow chart illustrating the iterative nature of the creative selection process and serves as a high level overview of the processes discussed in detail and illustrated by FIGS. 5 and 6. Design 710 of predictive models provides data for hypothesis testing 720 which is used to deactivate poor performing creatives. Some of any new and inactive creatives are activated, thereby modifying 730 the subset. Campaigns continue 740 based on the modified subset to collect performance data, which in turn leads to design 710 of predictive models based on the collected performance data and so on until a preferred set of creatives is identified, until no new elements are added or until other criteria is met.

This automated method generates performance comparison results for creatives and based upon whether the results meet certain user-input confidence level(s), the automated method will make decisions and take actions (activating and deactivating a creative) automatically. This is especially convenient for large-scale creative selection with many campaigns. Note that new elements of images, title, body or other factors may be added to test at any time. At certain points of the methodology (e.g. blocks 570 and 620), any new element(s) will be automatically incorporated into design 710, collection 720, modeling 730 and decision 740.

FIG. 8 is a table that illustrates the results of an exemplary design (block 530) that includes 2 active or selected creatives as a subset from 4 possible combinations. The table includes columns for the performance data including status, impressions, clicks, revenue and cost. Because the first two creatives were the subset that the campaign ran with they have performance data. The first selected creative has a status of active, shows 120,000 impressions, 56 clicks, 23 revenue units and a cost of $44.8. The second selected creative has an active status, 230,000 impressions, 210 clicks, 110 revenue units and costs $168. The third and fourth creatives show a hold status and thus, do not have entries for the performance data because they have not been part of a campaign.

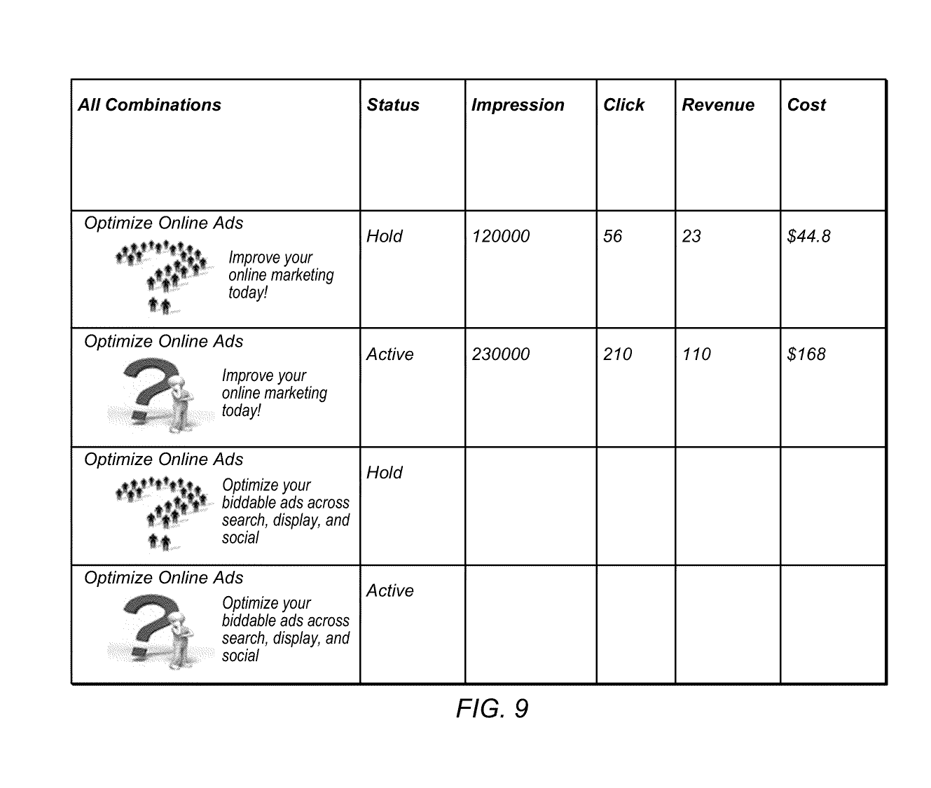

FIG. 9 is an updated version of the table in FIG. 8 after applying the herein described modeling (block 530) and hypothesis testing (block 540) to the performance data to select (blocks 560-580) from the creatives in FIG. 8. FIG. 9 illustrates the automated pausing or deactivation (blocks 540, 610) of creatives and the automated activation of creative (blocks 560-570, 620). Note that as a result of the automated deactivation and activation of creatives, the first and fourth rows of table in FIG. 8 have changed to hold and active in the table in FIG. 9, respectively. Now, campaign module 226 would launch another iteration of the campaign with the second and fourth creatives that now show an active status as the subset. Such automated deactivation and activation is supported by the sophisticated design, modeling, simulation and prediction techniques disclosed herein.

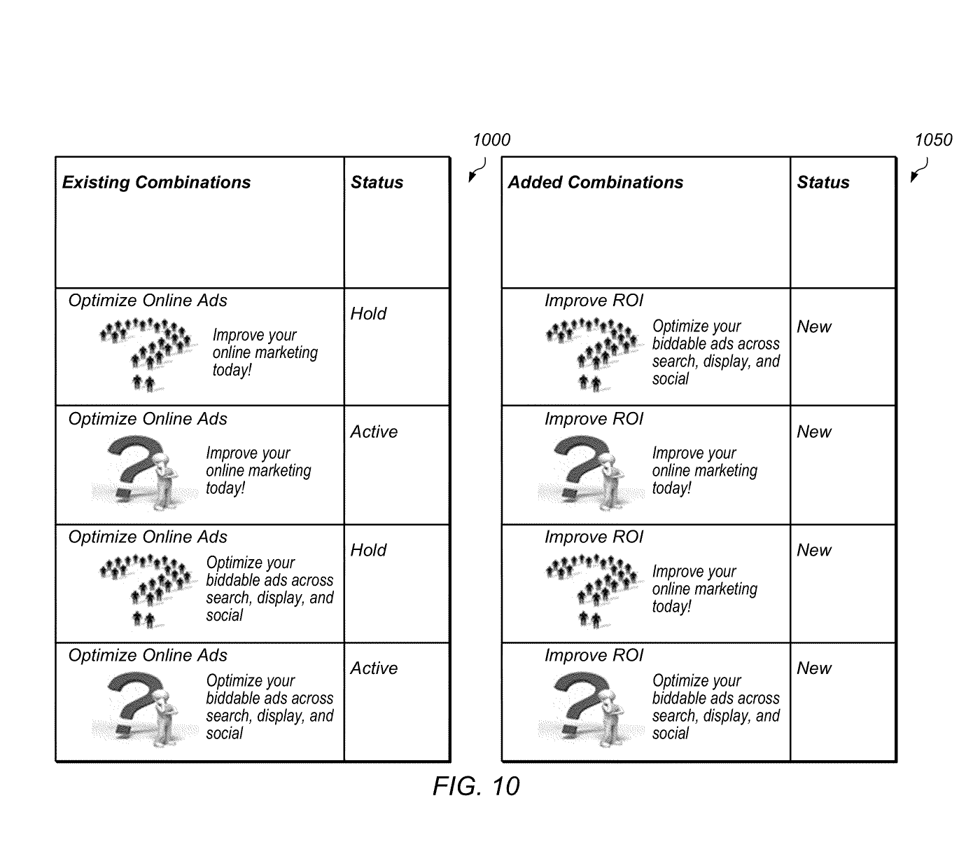

FIG. 10 illustrates the automated addition of new elements to the creative selection process, according to one embodiment. FIG. 10 illustrates the entire set of prior known creatives (table 1000) and new creatives (table 1050) for addition to the entire set of known creatives. When the creative manager 102 receives or finds a new creative element an augmented design (e.g. blocks 570, 620) is performed by the design module 230 to incorporate the new element into new creatives and a new subset. Note that the addition of a single new title increases the number of possible combinations. Of course, addition of just a few more elements or factors greatly increases the number of combinations. Here, 2 (titles)*2 (images)*2 (body)=8 total possible combinations. Note that the subset of selected creatives will remain at two for this example, although it could be increased in other examples. Status is provided for the existing combinations as illustrated. The first and third rows of table 1000 describe two of the existing creatives as having a status of hold. The second and fourth rows of table 1000 describe two of the existing creatives as having a status of active. The two active creatives are the ones in the current subset. New combinations can be seen in table 1050 where the newly added title element, “Improve ROI” has been combined with the other elements. All four rows of table 1050 show a status of new because they have not been part of a design yet.

FIG. 11 is a table illustrating convergence of the preferred creative selection process, according to one embodiment. FIG. 11 is an updated version of tables 1000 and 1050 that illustrate convergence to the preferred creatives. In this example, the creative selection process has run through several iterations and converged on two creatives. Notice that in FIG. 11 the second and fourth creatives in the existing combinations table 1100 now have a status of hold, where they had a status of active in FIG. 10 of table 1000. Also notice in FIG. 11 that first and fourth rows of the added combinations table 1150 have a status of hold and that the second and fourth rows of table 1050 have a status of active. In this example, it can be seen that creatives with the title, “Improve your ROI” and the image with the solid question mark are identified as preferred attributes of a creative because these two creatives are the two that the herein described systems and methodologies have converged on after several iterations.

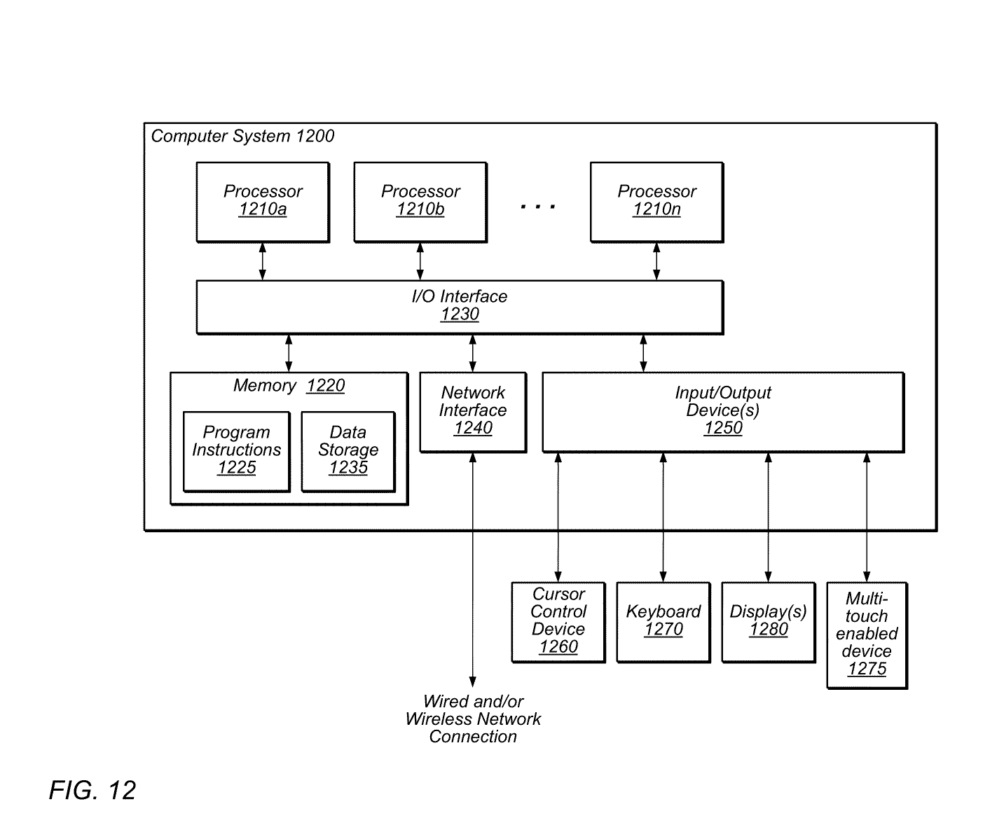

FIG. 12 illustrates an exemplary computer system for use in implementing the selection of a preferred subset of creatives, according to one embodiment.

### Preference (Performance) Metrics and Objectives

The proposed approach is general and not limited to any particular type of performance metrics. The performance here can broadly include any or a combination of various metrics or objectives. Whether to maximize or to minimize the performance metrics may depend on the underlying performance metrics.

Below is a non-exhaustive list of various metrics:

Click through rate (CTR)

Conversion rate

Revenue per click (RPC)

Revenue per impression (RPM)

Cost per click (CPC)

Cost per action (CPA)

Cost per impression (CPM)

The proposed approach selects creatives with creative factors (image, title, and text body). Those creative factors interact with audience targeting information (e.g. age, gender, location, education, interests). The proposed approach can be easily extended to incorporate those audience-targeting dimensions as well as their interactions with the creative factors into the modeling, testing, comparison, and selection process.

The proposed approach is for creative selection. However, it can be easily extended to fulfill more general advertisement selection purposes. For example, besides creatives, it can also select publishers, ads placements, audience targeting (age, gender, location, education, and etc.).

### Example System

Embodiments of a creative element selection system based on performance analysis and predictive modeling as described herein may be executed on one or more computer systems, which may interact with various other devices. One such computer system is illustrated by FIG. 12. In different embodiments, computer system 1200 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1200 includes one or more processors 1210 coupled to a system memory 1220 via an input/output (I/O) interface 1230. Computer system 1200 further includes a network interface 1240 coupled to I/O interface 1230, and one or more input/output devices 1250, such as cursor control device 1260, keyboard 1270, and display(s) 1280. In some embodiments, it is contemplated that embodiments may be implemented using a single instance of computer system 1200, while in other embodiments multiple such systems, or multiple nodes making up computer system 1200, may be configured to host different portions or instances of embodiments. For example, in one embodiment some elements may be implemented via one or more nodes of computer system 1200 that are distinct from those nodes implementing other elements.

In various embodiments, computer system 1200 may be a uniprocessor system including one processor 1210, or a multiprocessor system including several processors 1210 (e.g., two, four, eight, or another suitable number). Processors 1210 may be any suitable processor capable of executing instructions. For example, in various embodiments, processors 1210 may be general-purpose or embedded processors implementing any of a variety of instruction set architectures (ISAs), such as the x86, PowerPC, SPARC, or MIPS ISAs, or any other suitable ISA. In multiprocessor systems, each of processors 1210 may commonly, but not necessarily, implement the same ISA.

In some embodiments, at least one processor 1210 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1220 may be configured to store program instructions and/or data accessible by processor 1210. In various embodiments, system memory 1220 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a creative manager module are shown stored within system memory 1220 as program instructions 1225 and data storage 1235, respectively. In other embodiments, program instructions and/or data may be received, sent or stored upon different types of computer-accessible media or on similar media separate from system memory 1220 or computer system 1200. Generally speaking, a computer-accessible medium may include storage media or memory media such as magnetic or optical media, e.g., disk or CD/DVD-ROM coupled to computer system 1200 via I/O interface 1230. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1240.

In one embodiment, I/O interface 1230 may be configured to coordinate I/O traffic between processor 1210, system memory 1220, and any peripheral devices in the device, including network interface 1240 or other peripheral interfaces, such as input/output devices 1250. In some embodiments, I/O interface 1230 may perform any necessary protocol, timing or other data transformations to convert data signals from one component (e.g., system memory 1220) into a format suitable for use by another component (e.g., processor 1210). In some embodiments, I/O interface 1230 may include support for devices attached through various types of peripheral buses, such as a variant of the Peripheral Component Interconnect (PCI) bus standard or the Universal Serial Bus (USB) standard, for example. In some embodiments, the function of I/O interface 1230 may be split into two or more separate components, such as a north bridge and a south bridge, for example. In addition, in some embodiments some or all of the functionality of I/O interface 1230, such as an interface to system memory 1220, may be incorporated directly into processor 1210.

Network interface 1240 may be configured to allow data to be exchanged between computer system 1200 and other devices attached to a network, such as other computer systems, or between nodes of computer system 1200. In various embodiments, network interface 1240 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1250 may, in some embodiments, include one or more display terminals, keyboards, keypads, touchpads, scanning devices, voice or optical recognition devices, or any other devices suitable for entering or retrieving data by one or more computer system 1200. Multiple input/output devices 1250 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1240.

As shown in FIG. 12, memory 1220 may include program instructions 1225, configured to implement embodiments of a creative manager as described herein, and data storage 1235, comprising various data accessible by program instructions 1225. In one embodiment, program instructions 1225 may include software elements of embodiments of a creative manager as illustrated in the above Figures. Data storage 1235 may include data that may be used in embodiments. In other embodiments, other or different software elements and data may be included.

Those skilled in the art will appreciate that computer system 1200 is merely illustrative and is not intended to limit the scope of a creative manager as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1200 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1200 may be transmitted to computer system 1200 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc. In other embodiments, program instructions to implement embodiments as described above of data inputs or outputs for embodiments as described above, may be sent and/or received over transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method, comprising:
performing, by one or more computers:
selecting a subset of creatives from a group of creatives for a campaign;
collecting performance data for the campaign, wherein the performance data includes performance data for each creative of the subset;
constructing a predictive model based upon the performance data to predict performance of creatives from the group of creatives;
performing statistical hypothesis testing based on the predicted performance to determine one or more creatives of the campaign to deactivate;
selecting, based on the predicted performance for each creative, one or more creatives from the group of creatives to replace the deactivated creatives in the subset for the campaign; and
continuing the campaign and repeating for one or more iterations said collecting, said constructing, said performing and said selecting one or more creatives.

2. The method of claim 1, wherein said selecting a subset of creatives comprises generating each creative using a different combination of creative elements from a plurality of different creative element categories.

3. The method of claim 2, wherein said using a different combination of creative elements from a plurality of different creative element categories is performed in a manner ensuring that the subset of creatives includes a specified distribution of creative elements from each different creative element category.

4. The method of claim 1, wherein said collecting performance data comprises collecting network site analytics metric values from one or more data sources for each creative of the subset, wherein the performance data comprises data for one or more of impressions, clicks, revenue, costs, click through rate, conversion rate, revenue per click, revenue per impression, cost per click, cost per action, or cost per impression.

5. The method of claim 1, wherein the predictive model comprises a linear regression model, a generalized linear model, a decision tree, or a neural network.

6. The method of claim 1, wherein the predictive model is used to predict one or more performance metric distributions for each creative of the group, wherein said performing statistical hypothesis testing comprises applying simultaneous hypothesis testing using the performance metric distributions for multiple creatives to determine one or more creatives of the campaign to deactivate at a specified confidence level.

7. The method of claim 1, further comprising:
determining whether any new creatives have been added to the creative groups; and
in response to determining that one or more new creatives have been added, said selecting selects creatives from both the previous group of creatives and from the new creatives according to a specified ration.

8. The method of claim 1, further comprising, in response to determining that performance data for an initial subset of creatives for the campaign is insufficient to construct the predictive model:
perform hypothesis testing based on the collected performance data to determine one or more creatives of the campaign to deactivate; and
selecting one or more creatives from the group of creatives to replace the deactivated creatives in the subset for the campaign.

9. A system, comprising:
at least one processor; and
memory comprising program instructions that when executed by the at least one processor implement:
selecting a subset of creatives from a group of creatives for a campaign;
collecting performance data for the campaign, wherein the performance data includes performance data for each creative of the subset;
constructing a predictive model based upon the performance data to predict performance of creatives from the group of creatives;
performing statistical hypothesis testing based on the predicted performance to determine one or more creatives of the campaign to deactivate;
selecting, based on the predicted performance for each creative, one or more creatives from the group of creatives to replace the deactivated creatives in the subset for the campaign; and
continuing the campaign and repeating for one or more iterations said collecting, said constructing, said performing and said selecting one or more creatives.

10. The system of claim 9, wherein said selecting a subset of creatives comprises generating each creative using a different combination of creative elements from a plurality of different creative element categories, wherein said using a different combination of creative elements from a plurality of different creative element categories is performed in a manner ensuring that the subset of creatives includes a specified distribution of creative elements from each different creative element category.

11. The system of claim 9, wherein said collecting performance data comprises collecting network site analytics metric values from one or more data sources for each creative of the subset, wherein the performance data comprises data for one or more of impressions, clicks, revenue, costs, click through rate, conversion rate, revenue per click, revenue per impression, cost per click, cost per action, or cost per impression.

12. The system of claim 9, wherein the predictive model is used to predict one or more performance metric distributions for each creative of the group, wherein said performing statistical hypothesis testing comprises applying simultaneous hypothesis testing using the performance metric distributions for multiple creatives to determine one or more creatives of the campaign to deactivate at a specified confidence level.

13. The system of claim 9, further comprising:
determining whether any new creatives have been added to the creative groups; and
in response to determining that one or more new creatives have been added, said selecting selects creatives from both the previous group of creatives and from the new creatives according to a specified ration.

14. The system of claim 9, further comprising, in response to determining that performance data for an initial subset of creatives for the campaign is insufficient to construct the predictive model:
perform hypothesis testing based on the collected performance data to determine one or more creatives of the campaign to deactivate; and
selecting one or more creatives from the group of creatives to replace the deactivated creatives in the subset for the campaign.

15. A non-transitory computer-readable storage medium storing program instructions that when executed by a computer implement:
selecting a subset of creatives from a group of creatives for a campaign;
collecting performance data for the campaign, wherein the performance data includes performance data for each creative of the subset;
constructing a predictive model based upon the performance data to predict performance of creatives from the group of creatives;
performing statistical hypothesis testing based on the predicted performance to determine one or more creatives of the campaign to deactivate;
selecting, based on the predicted performance for each creative, one or more creatives from the group of creatives to replace the deactivated creatives in the subset for the campaign; and
continuing the campaign and repeating for one or more iterations said collecting, said constructing, said performing and said selecting one or more creatives.

16. The non-transitory computer-readable storage medium of claim 15, wherein said selecting a subset of creatives comprises generating each creative using a different combination of creative elements from a plurality of different creative element categories.

17. The non-transitory computer-readable storage medium of claim 16, wherein said using a different combination of creative elements from a plurality of different creative element categories is performed in a manner ensuring that the subset of creatives includes a specified distribution of creative elements from each different creative element category.

18. The non-transitory computer-readable storage medium of claim 15, wherein the predictive model is used to predict one or more performance metric distributions for each creative of the group, wherein said performing statistical hypothesis testing comprises applying simultaneous hypothesis testing using the performance metric distributions for multiple creatives to determine one or more creatives of the campaign to deactivate at a specified confidence level.

19. The non-transitory computer-readable storage medium of claim 15, further comprising:
determining whether any new creatives have been added to the creative groups; and
in response to determining that one or more new creatives have been added, said selecting selects creatives from both the previous group of creatives and from the new creatives according to a specified ration.

20. The non-transitory computer-readable storage medium of claim 15, further comprising, in response to determining that performance data for an initial subset of creatives for the campaign is insufficient to construct the predictive model:
perform hypothesis testing based on the collected performance data to determine one or more creatives of the campaign to deactivate; and
selecting one or more creatives from the group of creatives to replace the deactivated creatives in the subset for the campaign.
